(19) United States
(12) Patent Application Publication
(10) Pub. No.: US 2019/0066475 A1
(43) Pub. Date: Feb. 28, 2019

(54) TICK ALERT DEVICE

(71) Applicant: Terence J. Bordelon, Nashua, NH (US)

(72) Inventor: Terence J. Bordelon, Nashua, NH (US)

(21) Appl. No.: 15/974,045

(22) Filed: May 8, 2018

Related U.S. Application Data
(60) Provisional application No. 62/550,828, filed on Aug. 28, 2017.

(51) Int. Cl. G08B 21/02; A01M 1/22; A01M 29/24; G08B 6/00; A41B 11/00; A41D 17/00; A41D 1/06; A41D 13/00; A41D 1/00

(52) U.S. Cl. CPC G08B 21/02; A01M 1/223; A01M 29/24; G08B 6/00; A41D 2600/10; A41D 17/00; A41D 1/06; A41D 13/001; A41D 1/002; A41B 11/00

(57) ABSTRACT

A tick detecting device for detecting ticks or other insects on the device which includes a signal generator for generating a detection waveform or DC voltage sufficient to traverse ticks; at least one pair of conductive traces driven by said signal generator, adapted to be in a path of ticks traversing the device; a detector for detecting the generated signal from said signal generator and any deviations caused by a tick in contact with said pair of conductive traces; a filter for discriminating between tick and no tick signals received from at least one of said pair of conductive traces; and a device for notifying a user of the detection of presence of a tick.

### CROSS REFERENCE TO RELATED APPLICATIONS

This application claims the priority of Provisional Application No. 62/550,828 filed on Aug. 28, 2017, inventor Terence J. Bordelon, entitled “Tick Alert Device”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The invention relates to a tick alert device that warns a wearer of the presence of a tick on the device.

### BACKGROUND OF THE INVENTION

Many solutions exist to defend hikers against ticks, but current solutions depend on undesirable chemical deterrents, or physical barriers, and provide no warning to the user. There is a need to deter ticks from biting hikers with methods that do not involve uncomfortable changes to wardrobe, as well as a need to notify the user of the presence of the ticks in order that the user may move to a safer area and inspect their body in order to remove the tick.

### SUMMARY OF THE INVENTION

According to one aspect, a tick alert device includes a wearable band having an exposed surface containing a pattern of electrically conductive traces positioned to be bridged by a tick attempting to traverse the band; a signal generator connected to drive the conductive traces at a voltage sufficiently high, and with a frequency and/or pulse duration sufficient to detect a tick bridging conductive traces without creating a shock hazard to the wearer; a detector and optional filter having an input connected to detect a signal produced by a tick bridging conductive traces, and an output connected to a device for providing a notification signal to the user. Preferably, all components are all embedded in material forming the band.

The recommended location for wearing a pair of devices is shown in FIG. 2. Ticks are generally introduced to the human body on the shoes and lower legs while walking through the environment tall grass, etc. Each device lies in the path of any climbing tick on that leg, and it becomes impossible for the tick to cross over the device without being detected. Ideally, the device is worn with shorts and below the knees to catch ticks early in their ascent up the body. Less ideal is the same location, but under jeans or pants. The device may also be worn over or integrated into clothing, in which case it presents a detection area on the clothing, and may present a physical barrier under the clothing by holding the clothing against the skin.

### BRIEF DESCRIPTION OF THE DRAWINGS

Embodiments of the invention will now be described by way of example only, with reference to the accompanying drawings in which:

FIG. 1 is a schematic perspective of a first embodiment of the tick alert device according to the invention;

FIG. 2 is a diagrammatic view of a person wearing a tick alert device wearable band on each leg;

FIG. 3 is a schematic cross section of an embodiment containing a “gasket” of material intended to close any gaps between the wearer and the device;

FIG. 4 is a block diagram of the functional components showing the device;

FIG. 5 is a flow chart of a software implementation of the preferred embodiment;

FIG. 6 is a diagram of the circuitry of the first embodiment of the tick alert device;

FIG. 7A is a fragmentary plan view of a first possible trace geometry, specifically a non-overlapping geometry;

FIG. 7B is a fragmentary plan view of second possible trace geometry, specifically an overlapping geometry;

FIG. 8A, FIG. 8B, and FIG. 8C are respective electrical block diagrams showing possible ways to attach conductive traces to generator and detector;

FIG. 9 is a diagrammatic perspective view showing an exploded view of a second embodiment of the tick alert device;

FIG. 10 is a fragmentary plan view of an embodiment with a buckle and with one offset and one overlapping end;

FIG. 11 is a diagrammatic view of a person wearing a tick alert device integrated into leg-warmers or gaiters;

FIG. 12 is a diagrammatic view of a sock with a tick alert device integrated therein;

FIG. 13 is is a fragmentary plan view of an embodiment with optical components instead of conductive traces

FIG. 14 is a schematic perspective view of another embodiment of the tick alert device in a simple ring of band material with no buckle;

FIG. 15 is a fragmentary diagrammatic cross-sectional view of an embodiment with a tapered end and guides for alignment

FIG. 16 is an electrical block diagram of filtering and detection in a preferred embodiment;

FIG. 17 is a diagrammatic cross-sectional view of an embodiment with an early detection feature.

FIG. 18A, FIG. 18B, FIG. 18C, and FIG. 18D are graphs depicting signals and events related to the operation of the circuit arrangements of FIG. 8A, FIG. 8B, and FIG. 8C.

FIG. 19 shows one possible arrangement of LEDs on the band.

### DETAILED DESCRIPTION OF THE INVENTION

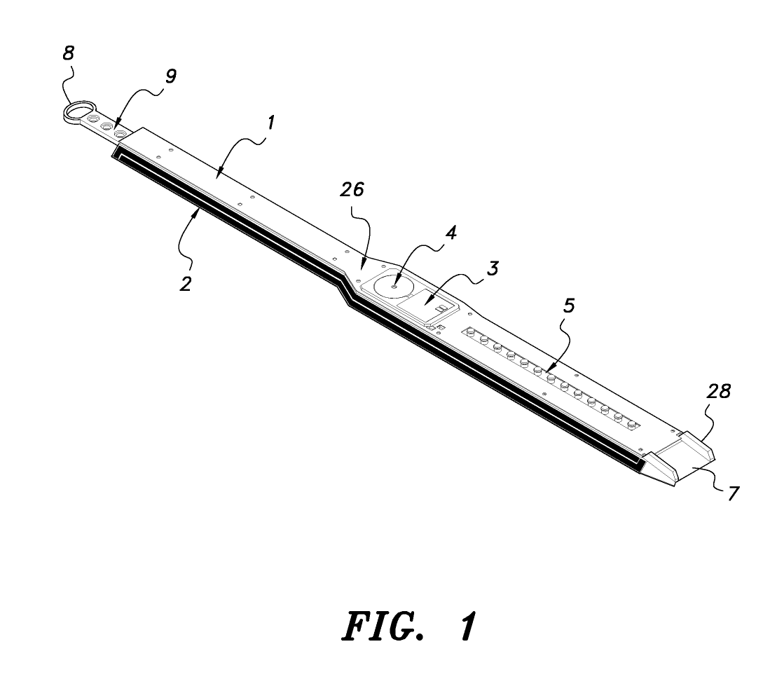

FIG. 1 is a schematic perspective of a first embodiment of the tick alert device according to the invention. Referring to FIG. 1, in this preferred embodiment, a band 1 is made of an elastic or stretchable material, in whole or in part, such that when worn it is in tension and holds itself against the wearer's skin. This force tends to close any gaps between the band and the user's skin. Further, a pair of conductive traces (shown in the drawings by the numeral 2) are an arrangement that preferably provides no gaps or regions for the tick to bypass, such that no ticks may escape detection.

The conductive traces 2, in order to stretch along with the band 1, is composed of any of: stretch fabric, conductive silicone or rubber, stretchable conductive ink, or any other elastic conductive material able to stretch with the band 1. The device of FIG. 1 includes a user notification device 4, described further below. The portion 3 of FIG. 1 indicates where circuitry is provided, which corresponds to the circuitry described further below and shown in the accompanying drawings. FIG. 1 indicates an upstanding portion 28, a pair of which are provided (the second one being unnumbered in FIG. 1), connected by a flat connecting portion 7. The band includes a portion 28 serves as an additional guide feature, which may appear at the end of the band.

It is also possible to employ a rigid band material 1, in which case the traces 2 could be composed of the above materials but could also be composed of rigid conductive traces 2 such as metal, and in this case extra care in design is needed to close any gaps between the band and the user's skin.

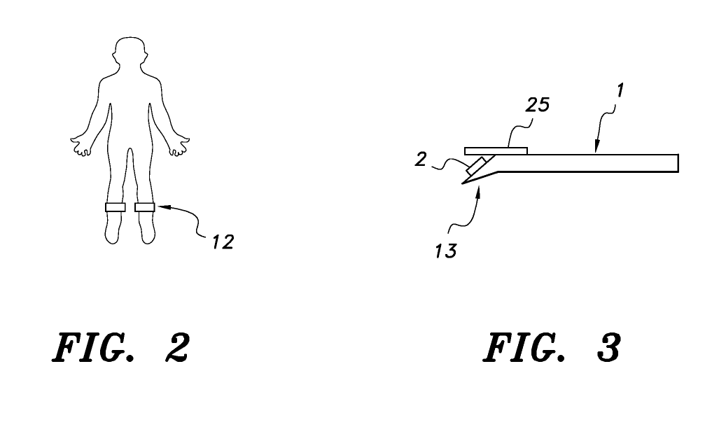

FIG. 2 is a diagrammatic view of a person wearing a tick alert device wearable band on each leg.

FIG. 3 is a schematic cross section of an embodiment containing a “gasket” of material intended to close any gaps between the wearer and the device.

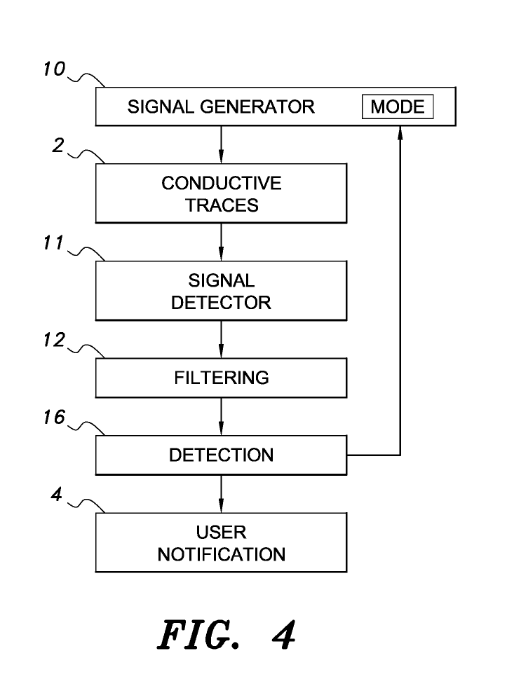

FIG. 4 is a block diagram of the functional components showing the device.

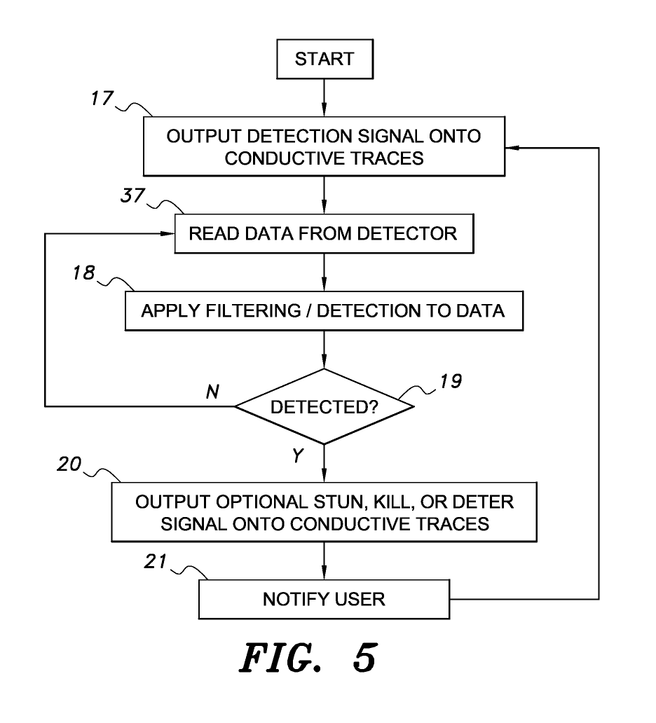

FIG. 5 is a flow chart of a software implementation of the preferred embodiment.

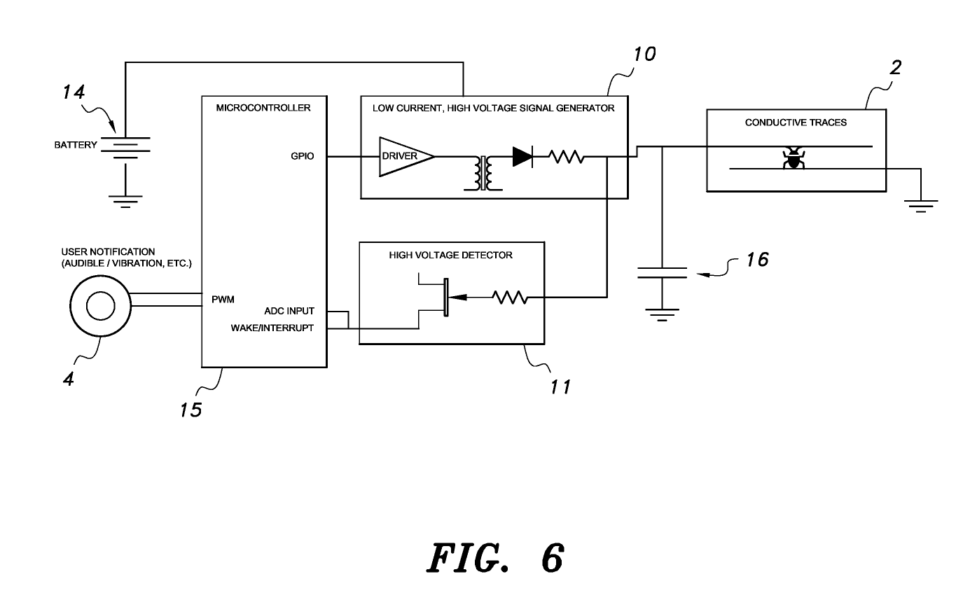

FIG. 6 is a diagram of the circuitry of the first embodiment of the tick alert device.

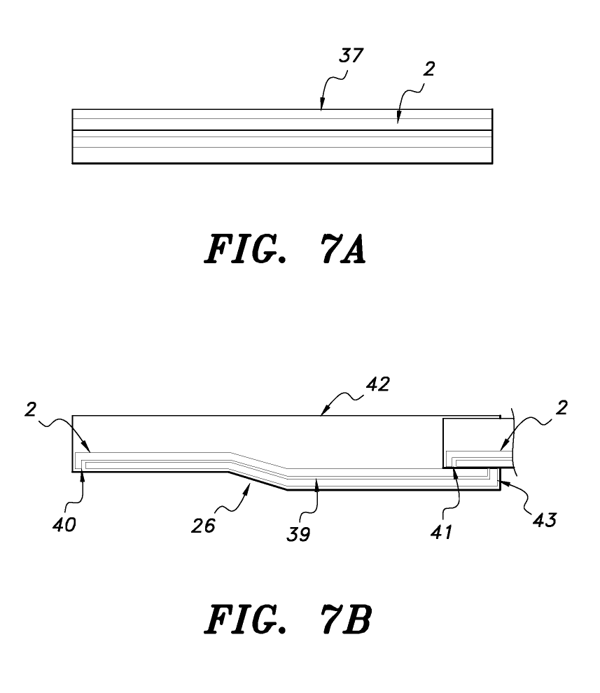

FIG. 7A is a fragmentary plan view of a first possible trace geometry, specifically a non-overlapping geometry.

FIG. 7B is a fragmentary plan view of second possible trace geometry, specifically an overlapping geometry.

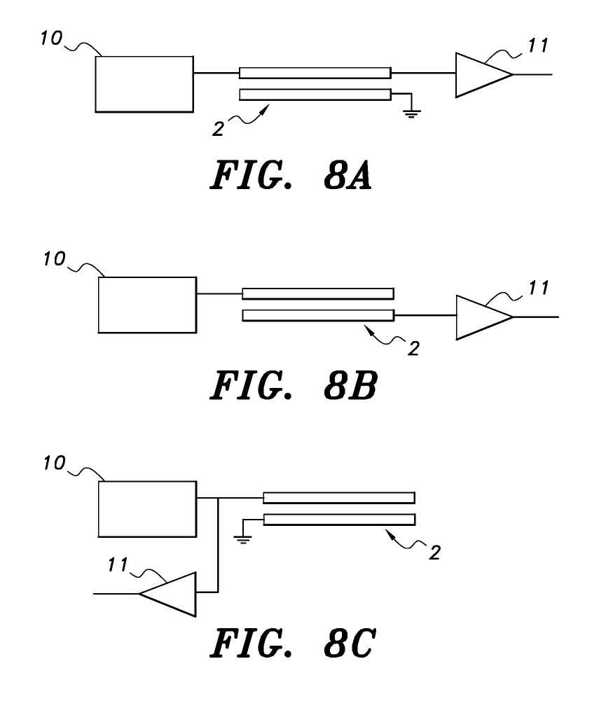

FIG. 8A, FIG. 8B, and FIG. 8C are respective electrical block diagrams showing possible ways to attach conductive traces 2 to the generator 10 and the detector 11. These figures show three different configurations of signal generator 10, conductive traces 2, and detector 11. In these figures, a unipolar signal is represented by the connecting lines and is referenced to system ground, however a bipolar or AC signal could also be utilized (not shown). In these views, a tick (not shown) crossing the pair of traces 2 would trigger detection, as discussed further below.

In FIG. 8A, a signal generator 10 drives one trace, while the opposite trace is grounded. The detector 11 monitors the driven trace for changes in the signal, which tends to reduce in magnitude with a tick present. In FIG. 8B, a signal generator 10 drives one trace 2 while the detector 11 receives the signal from the opposite trace. When a tick is present, the signal tends to appear or greatly increase in magnitude. In FIG. 8C, the two traces form a transmission line of a characteristic impedance, and the generator and detector are connected on the same side of the trace pair in order to function as a TDR (Time Domain Reflectometer). When a tick is present, a change in timing occurs between the sent and received pulse timings.

In all cases, the detector 11 receives a signal produced by the generator 10 after traveling through the traces 2 with either a tick or no tick present across the two traces. The detector is a voltage measuring device, preferably with high input impedance.

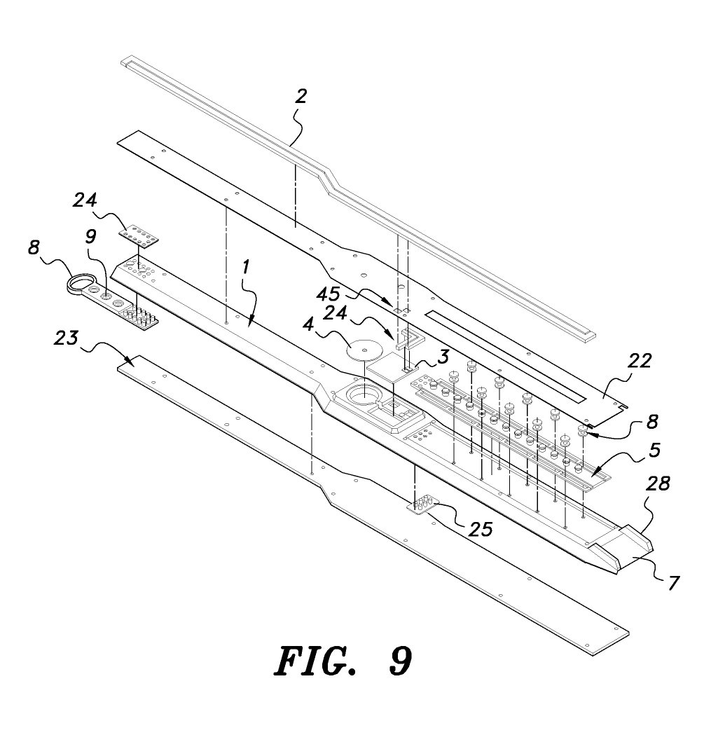

FIG. 9 is a diagrammatic perspective view showing an exploded view of a second embodiment of the tick alert device.

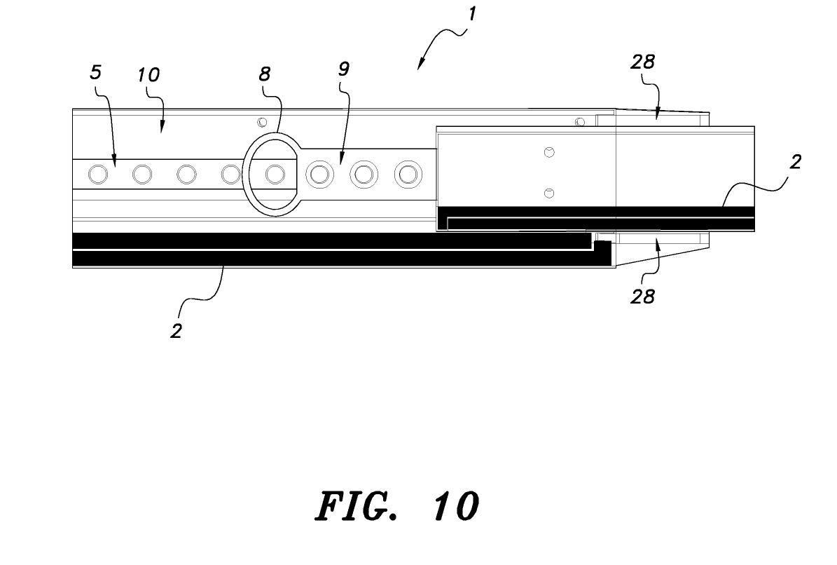

FIG. 10 is a fragmentary plan view of an embodiment with a buckle and with one offset and one overlapping end.

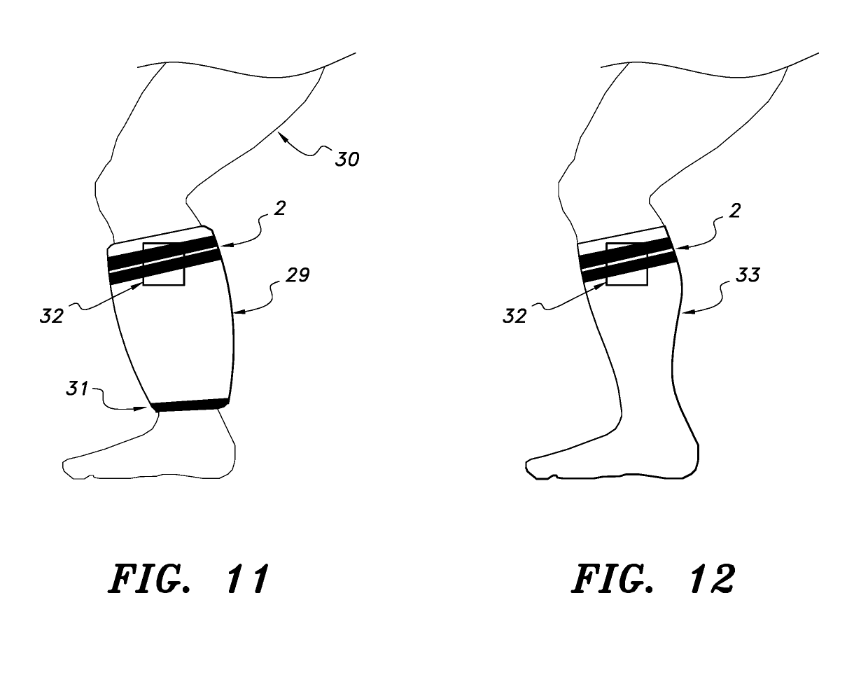

FIG. 11 is a diagrammatic view of a person wearing a tick alert device integrated into leg-warmers or gaiters.

FIG. 12 is a diagrammatic view of a sock with a tick alert device integrated therein.

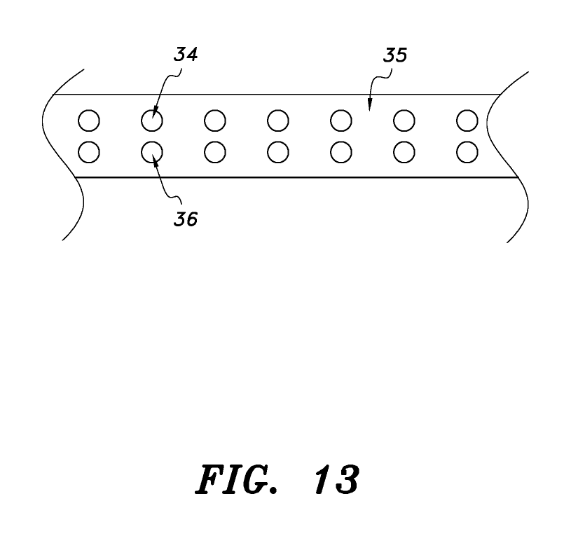

FIG. 13 is is a fragmentary plan view of an embodiment with optical components instead of conductive traces.

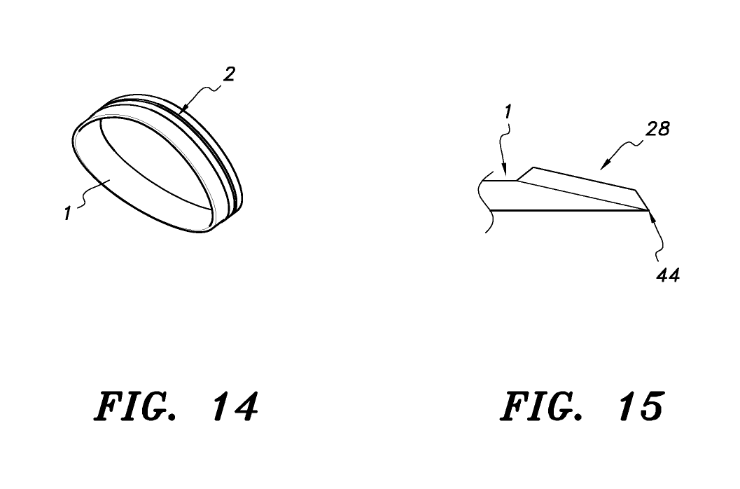

FIG. 14 is a schematic perspective view of another embodiment of the tick alert device in a simple ring of band material with no buckle.

FIG. 15 is a fragmentary diagrammatic cross-sectional view of an embodiment with a tapered end and guides for alignment.

FIG. 16 is an electrical block diagram of filtering and detection in a preferred embodiment.

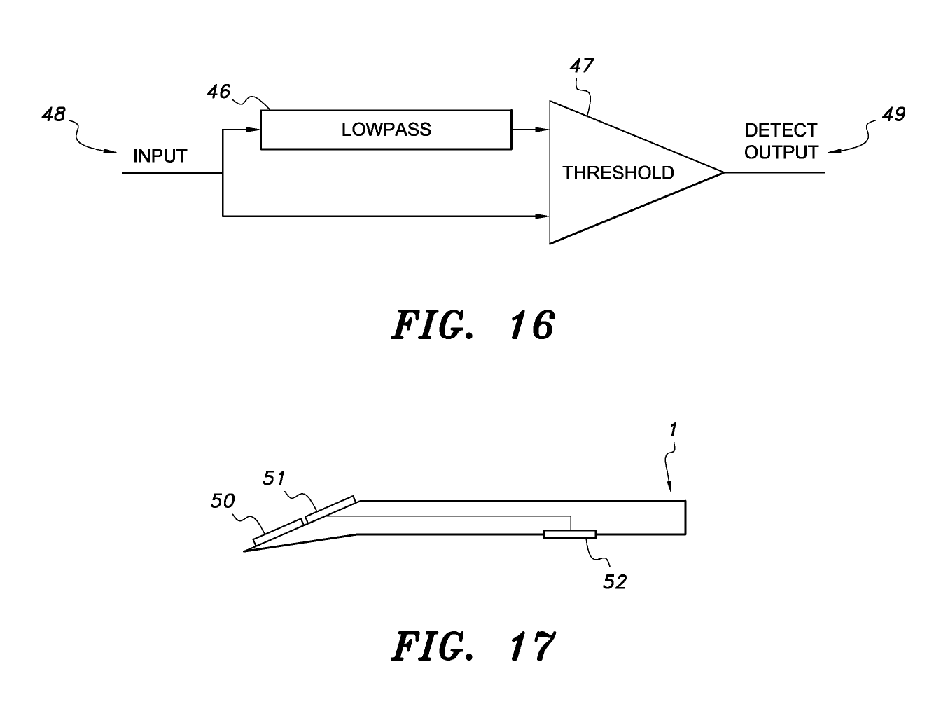

FIG. 17 is a diagrammatic cross-sectional view of an embodiment with an early detection feature.

Depending on the construction of the band material, thickness, elasticity, durometer chosen, etc., a gap may appear between the user skin and the band. This gap may be closed by adding additional material on the bottom edge in order to form a type of gasket which presses onto the user's skin. One way to accomplish this is shown in FIG. 3, with an edge 13 of the band material 1 extending diagonally down below the bottom of the band 1. In addition, any standard gasket geometry can be used to accomplish this.

FIG. 3 also demonstrates an optional shroud 25 over some or all of the traces 2. The shroud 25 can be made of any suitable material, preferably waterproof or of any desired qualities with the goal of protecting the traces 2. This feature can be included in order to protect against sweat, rain, or other unwanted sources of false alarms. Such a shroud 25 may cover all or part of the trace area, but will preferably remain open toward the bottom of the band in order to allow ticks to access the trace area. The gap between the traces 2 and the shroud 25 presents some risk that the tick may crawl on the shroud material 25 and bypass the traces 2, so the gap between the two must be large enough to prevent this. Gaps of 0.05″ or greater are recommended. The shroud can be removable as in a preferred embodiment, or can be designed to move in order that the user may access the trace area below. If the band material is elastic, the shroud 25 should also be designed to be elastic to avoid preventing the band 1 from stretching.

In a preferred embodiment as shown in FIG. 1, a buckle peg board 5 and peg holes 9 can be used on the band 1, wherein the pegs from the peg board 5 can be received within the peg holes 9. Alternatively, other fastening and adjustment systems can be used which are known to any one having skill in the band fastening arts, including magnets, Velcro(®), snaps, buttons, folding section, and so on, which can be provided to allow adjustment for comfort and fit. The geometry of such a fastening and adjustment system is not crucial to the invention, except that such a buckle should preferably not allow for any gaps which can allow the tick to bypass detection, and should preferably hold the band firmly against the skin, and should preferably not allow any path for traversing underneath the band against the wearer's skin or between any overlapped section, or across the buckle itself, or else detection may be compromised.

In a preferred embodiment, referring to FIG. 9, conductive traces 2 are laminated onto a stretch fabric such as Lycra(®) 22. The underside of this fabric is laminated with flat conductive material 24 positioned in order to connect the conductive traces 2 on the opposite top side with the circuit board below two through holes 45 in the fabric 22. The holes 45 are square, and the additional round hole shown is for alignment. The buckle peg board 5 is held in a channel (unnumbered) in the band 1 provided with pegs 8 which allow the buckle to slide freely within the channel such that the band's ability to stretch is not compromised.

The buckle 5 is anchored to the band 1 at its leftmost end with part 25, and provides the only hard attachment point between buckle peg board 5 and the band 1. The mating peg holes 9 are attached with part 24. Parts 9 and 24, and 25 and 5, are respectively preferably glued together with any compatible glue, but may alternatively be designed to snap together or otherwise attach without glue. Alternatively, if a fabrication design is made to allow it, these parts may be molded into the band material 1. Optional fabric or other material on the bottom of the band 23 can be chosen for user comfort, and to protect the user's skin from items on the band that may cause discomfort. Material 22 and 23 is laminated to the band and is selected for comfort, strechability, moisture repelling or absorbing qualities, and other characteristics that help protect the conductive traces 2 from sources of false alarm.

FIG. 10 demonstrates the preferred embodiment with an adjustable band 1 containing an area of overlap. The geometry and layout of the conductive traces 2 are arranged such that there is no path for a tick to cross the band without crossing a pair of traces even in the overlapping area. This is not a necessary feature, but is preferred as it helps prevent ticks from escaping detection.

In the embodiment shown in FIG. 1, the inelastic buckle peg board 5 contains all pegs at a fixed distance and is firmly attached or integrated into the band material 1. Even though this design prevents the band material itself 1 from stretching and having tension underneath the buckle area 5, the band material is held firmly against the user's skin since the buckle peg board 5 will be in tension.

Referring to FIG. 9 and FIG. 10, the portion 28 serves as an additional guide feature, which may appear at the end of the band. This guide 28 restricts the location of the initial point of overlap, and helps to ensure the overlapping portion is not misaligned. Since the band 1 must overlap within the guide 28, the tension of the band 1 from the buckle to the overlap ensures a straight line. Further, it is recommended that the end of the band 1 under any area of overlap should taper to be as thin as practical in thickness near the end of the band in order to avoid introducing a gap large enough for a tick to fit under the band 1. If the band material 1 is already very thin, this feature can be omitted.

Referring to FIG. 3, a preferred embodiment, the bottom edge of the band 1 has a tapered portion 13 such that it presents the tick with a gradual climb rather than an abrupt change in height above the user's skin. In order to avoid creating areas too thick for ticks to traverse with bands that have one end overlap onto the other, the overlapping area may be designed in such a way that the tapered edges do not lay on top of one another, but when overlapped, creates two areas of taper for the tick to traverse. This could be accomplished by ensuring that the overlapping band portion is slightly offset, and is accomplished as shown in FIG. 1 at region 26 by having one side of the band shifted relative to the opposite side. This creates an overlap as demonstrated in FIG. 10 wherein the tapered edges do not lie directly on top of one another, and the tick is presented with the same climb angle in the area of overlap as it does in the areas that do not overlap. This prevents any abrupt change in height that may deter the tick from proceeding across the band in the overlapping areas.

Referring to FIG. 14, showing another embodiment, the buckle peg board 5, peg holes 9, and guide 28 may be omitted entirely, and the band material 1 and traces 2 constructed to form a ring shape, which can be slid onto the user's arms, legs, or body. In such an embodiment, the band 1 is ideally made of an elastic material and is not rigid.

The functional diagram of the device is shown in FIG. 4. A signal generator 10 produces a signal. This signal is applied to the conductive traces 2. The signal is received by a signal detector 11 after passing across or through the traces 2, optionally filtered as shown at filtering element 12 to eliminate or reduce false alarms, followed by a detection block 16 determining pass/fail (YES/NO) on whether the signal is likely to be a tick. When a tick is detected, a detection signal D is produced and supplied to the user notification device 4.

In FIG. 4, the signal generator block 10 is controlled by the mode signal M, which can be either DETECT or STUN. This is an internal signal sourced from detection. So when it detects a tick, mode=stun, otherwise mode=detect. Optionally, the mode signal may be fixed in either stun or detect permanently. Stun signals may also be used for detection at the expense of battery life.

The signal produced 10 may be boosted in magnitude in order to stun, killed, or deter the tick by changing the signal generator mode, or desired signal to generate. Any or all of these blocks may be implemented in a microcontroller 15, FPGA (Field Programmable Gate Array) an ASIC (Application Specific Integrated Circuit) or custom silicon, or using analog components. The signal detector 11, filtering element 12, detection element 16, and user notification element 4 may be omitted, and the signal generator 10 set to output a stun, kill, or deter voltage signal permanently. Also, the detection element 16 may be omitted, and the user given a continuous notification of some quality of the received signal. The filtering element 12, the detection element 16, or both may be omitted at risk of increased false alarms but perhaps reduced cost. It is important to note that the signal generator 10 and signal detector 11 may be connected to one or both traces depending on the desired mode of operation. The presence of a tick can either modify a continuously detected signal, or cause it to appear only when the tick is present, see FIG. 8A, FIG. 8B, and FIG. 8C.

The presence of a tick will modify the generated signal as it travels through the traces and tick. In the case of FIG. 8A, the signal tends to attenuate when a tick is present. In the case of FIG. 8B, the presence of a tick tends to increase the signal present. In the case of 8C, the presence of a tick tends to change the timing and polarity of reflected pulses sent into the traces, which function as a transmission line in a TDR (Time Domain Reflectometer) mode.

FIG. 6, a preferred embodiment, is implemented using a microcontroller. As discussed above, several of the functional blocks in FIG. 4 are preferably implemented in software. Program flow is shown in FIG. 5. A Microcontroller commands the signal generator in block 17 to output the desired detection signal. This may be implemented with hardware blocks, or in software. A loop wherein new data is processed through the filtering and detection algorithms and a pass fail is checked occurs in blocks 37, 18, and 19. This loop exits when detection passes. Once this occurs, an optional stun, kill, or deter signal is output 20 and the user notified 21. The loops in blocks 37, 18, and 19 may be implemented in a thread, ISR (interrupt service routine), or in hardware to avoid blocking execution. A signal, interrupt, or flag upon successful detection can modify execution to take the actions in subsequent blocks without causing the CPU to waste cycles or power, and can even allow the microcontroller to sleep and wake up on detect.

In a preferred embodiment, referring to FIG. 6, a battery 14 is provided which is a low voltage battery, generally a few volts. An optional on/off switch can be provided, which can simply be a plastic insert removed upon opening of the packaging which permanently connects the battery, or a switch/button installed on the band. A micro-controller 15 drives the conductive traces 2 with voltage, either pulsed, continuous, or with an AC waveform able to traverse the target tick. When a tick is present, current flows causing a modified signal to appear at the output of the signal detector 11. This output is fed into the microcontroller's ADC, GPIO, or comparator pin. Referring to FIG. 4, software filters 12 and detection elements 16 provide signals that are likely to be caused by a tick. If these steps pass (i.e. in a pass/fail setup), the microcontroller 15 notifies the wearer by way of a suitable feedback, such as an LED, piezoelectric, or haptic transducer 4. Key to safe operation of the device is proper implementation of the signal generator in FIG. 6, block 10. The voltage, pulse duty cycle, duration, current, and other characteristics must be selected not only to pass through the desired tick species, but to be safe and ideally undetectable by the wearer when contacted. In this embodiment, pulse duration is kept short and current limiting circuitry provided to meet these criteria. For this embodiment, any traditional method of generating the desired voltage may be employed, including using direct battery voltage, boost converter, inductor, flyback transformer, voltage multiplier, or similar. Short duration high-voltage pulses of 10 us at a frequency of 200-300 hz, an amplitude of 400 volts, and a current of 0.1-0.5 milliamps were found sufficient to detect deer ticks reliably. Low voltages below 100 v may be used, even down to below 10 volts but these reduced voltages are not recommended. Low voltage does not always traverse a given tick, provides less signal for the detector, making detection much more difficult. Even in the same species of deer tick, while some test specimens could be detected with voltages as low as 10 or 5 volts, others required a minimum of over 100 volts. In this embodiment, simple filtering and detection are performed in software.

FIG. 16 shows one possible implementation of the filtering and detection algorithm for this above-described embodiment. The input signal 48 is first low pass filtered with a time constant of several seconds, and a threshold voltage established 46. A threshold detector 47 compares the low passed signal with the unfiltered input signal. Detection passes when the signal received changes by more than a percentage usually 25% of the lowpass output. Detection output 49 is true when this condition is met, false otherwise.

In a preferred embodiment, referring to FIG. 6, the detector 11 is implemented with a FET Field Effect Transistor which is chosen because it is high-impedance, but any suitable detector may be used, such as an op-amp. In this figure, the FET input is attached to the high-voltage, driven trace 2. It is also acceptable to attach the input of the detector to the opposing trace 2 instead of grounding it directly. This arrangement is more susceptible to current leakage and false alarms caused by humidity or contaminants between the traces and is not recommended. In either case, it is suggested that a high-impedance detector circuit be used in order to handle high-resistance ticks and/or to insure low power operation. Conversely, too high of an input impedance is susceptible to noise and static electricity. In the preferred embodiment, an input impedance of ˜50 k is found to be a good compromise. Referring to FIG. 6, resistors or other current limiting circuitry may be optionally present in the detection pathway in order to lower the current to desired and/or safe levels. Alternately the generator 10 may already output the desired current, in which case this is omitted.

The generated signal may be selected to only detect, or to simultaneously detect as well as stun, kill, or deter. This can be accomplished by varying the waveform, pulse width, voltage, or current present on the conductive traces 2. In a preferred embodiment, this is done in such a way as to remain safe to the wearer. The same strategy used to generate the detection voltage and current can be increased but not overly so in order to achieve stun, kill, or deter, yet remain harmless if the wearer accidentally makes contact. To insure a successful stun, kill, or deter of most ticks, a voltage of 200-600 v is used to guarantee success. Lower voltage below 100 volts has some deterring effects, but is inconsistent in effect, and not sufficient to prevent all ticks from traversing the band. Any waveform may be used, with increasing duty cycle having a greater effect.

The signal present on the conductive traces 2 may be chosen to be a very high frequency approaching many KHz or MHz, such that it is considered “radio frequency energy” RF. In this case, instead of detecting high-voltage, the detector is instead optimized for detection of the emitted RF signal. This variation, and other variations in the circuits shown and described in the present invention discussed herein, would be within the ambit of skill (and known and understood) by any one having skill in the signal detection circuit design arts. The tick is then detected when the received RF signal is modified by its close proximity or contact with the conductive traces. In addition to high frequency RF, the signal present on the conductors may be DC, AC, pulsed DC voltage, or any arbitrary waveform. In the case of very low voltage DC, the signal generator may simply be a connection to the battery. To improve detection, the signal may be modulated in any convenient way frequency, pulsed, or using any other characteristic such that the detector can filter or discriminate based on the modulation in order to determine a valid signal is present, eliminating false detection when unwanted external voltages are received by the traces. While conduction is the preferred mode of detection, in an alternative embodiment it is also possible to use capacitive detection (not shown) in the invention with potentially increased false alarms. Capacitive detection is known in the electronic arts for detection of a change in the electrical field causes by passage of an object near such a field.

Referring to FIG. 4, analog circuitry may be used to construct the signal generator 10 and/or detector 11. For example, generation can be accomplished with a simple oscillator, and the detector may be a transistor, MOSFET, or even drive the user notification 4 transducer directly without any micro-controller present. For the microcontroller based embodiment in FIG. 6, a capacitor 16 may be added on the output of the signal generator 10 in order increase circuit capacitance. This will allow the generator to energize the traces 2 by charging the capacitor 16. The micro-controller can then enter a low-power mode sleep without having to further drive output to the conductive traces 2. The micro-controller can then wake upon an interrupt generated by detected signal caused by the discharging capacitor conducting through the tick. In this mode, the micro-controller will naturally have to periodically wake to recharge the capacitor to maintain appropriate voltage on the conductive traces 2 but can remain in a lower power state for brief intervals. The output of the capacitor may necessarily have a current limiting resistor in series with the conductive traces to provide safety.

Referring to FIG. 8A, FIG. 8B, and FIG. 8C, various ways the traces 2 may be connected to both generator 10 and detector 11 are shown. In these views, AC or DC waveforms of the chosen characteristics may be output to one or both traces, and detected from one or both traces.

In another embodiment, referring to FIG. 4, multiple sets of traces 2, detectors 11, or entire sets of these functional blocks may be used in order to allow operation in the event that one set becomes inoperable, or to alert the user as to the general location of the detected tick by giving user feedback as to which set is alerting.

Moisture on the traces can make detection difficult or create false alarms. Several methods may be employed to help with this issue. In FIG. 1, Moisture absorbing band material 1 can be used, or even laminated to the top of the core band material. If fabric is used on the band surface, adding water-proofing chemicals into the fabric can prevent the fabric from wicking up moisture or sweat and causing false alarms. Sealing the gaps between the traces 2 with waterproof material such as silicone also helps prevent moisture induced false alarms.

The particular arrangement of the conductive traces shown in FIG. 1 is not critical to the invention. Parallel conductors or any other pattern of conductors meeting these criteria may be used. The traces are ideally patterned such that a tick cannot find a path across the device without crossing between a pair. The spacing between the traces should be close enough to detect the smallest tick, but not close enough to trigger false alarms caused by arcing or moisture. The preferred embodiment uses a spacing of 1 mm which is sufficient to avoid false alarms and detect most ticks.

Referring to FIG. 7A and FIG. 7B, two possible trace geometries are shown FIG. 7A shows a band 37, which is a continuous ring where the left side wraps around to the right, in which there is seen a simple arrangement of two traces 2 extending down the band horizontally. This simple design does not preset a tick with any possible path with which to bypass these two traces. A band 42 is shown in FIG. 7B, which is more complex in that it is overlapping. The band 42 of FIG. 7B is not continuous, but is worn such that the left side overlaps the right side. For overlapping bands, an offset 26 is recommended in order to prevent traces from overlapping directly on top of one another and creating a thick area that may prevent or deter ticks from progressing across. For this overlapping case, the traces 2 in a preferred embodiment have features which prevent any bypass pathways caused by the overlap. The left end of the band 40 has an upper trace which turns toward the bottom of the band. When this side overlaps as shown on the right side 41, it prevents ticks from simply crawling on the lower trace horizontally until it bypasses detection. On the right end, the bottom trace turns upward 43 to prevent a tick from walking along the upper trace horizontally and bypassing detection.

If the band material is thin enough, an overlapping band such as shown in FIG. 7B can be provided in the embodiment shown in FIG. 7A (i.e. with the same design as band 37) will work, since the complexity caused by the offset 26 is not present. This invention does not require traces to be in this arrangement, or even that the traces be rectangular of significant length. Instead, the traces 2 could be arranged in other ways, including non-linear arrays, non-uniform thicknesses, and even as an array of circles. All such designs would preferably demonstrate ways to arrange the trace geometry to prevent possible paths for ticks to avoid detection.

Referring to FIG. 17, an early detection feature can be provided on band embodiments worn directly on the skin. FIG. 17 shows the usual trace pair 50 and 51, however this feature requires an additional trace on the underside of the band, in contact with the user's skin 52. The opposing trace 50 must be placed very close to the bottom edge of the band such that it is still isolated from the user's skin but positioned to be touched by the tick when it first encounters the band. On occasion, ticks will encounter a change in terrain in this case, the edge of the band and initially back away. With this enhancement, the user's skin becomes part of the detection circuit. The tick is indirectly contacting one trace 52 when touching the user's skin. Then, when it touches the single trace at the very edge of the band 50, the circuit is completed, and early detection occurs. When using the early detection feature, trace 51 is optional.

The wearer may be alerted not only with a vibratory or audible alert, but the detection circuitry may also employ RF telemetry such as Bluetooth™ and/or Wi-Fi. This can be used to send detection status to a remote device such as a tablet or cell phone. If multiple sets of traces are present on the band, the user can be alerted as to which set has detected the tick.

While the primary description of embodiments in this document refer to ticks, the device is capable of detecting other insects including spiders and ants, and may be optimized to detect these and other species.

Referring to FIG. 4, in another embodiment, a signal generator is designed to continuously deter or stun/kill, and all other blocks are omitted except elements 10 and 2, and the mode is permanently set to deter or stun/kill. This form of the invention necessarily gives up the detection aspect.

Referring to FIG. 11 and FIG. 12, any article of clothing which is in the path of ticks climbing on the body can be used to mount the invention, instead of a band. The material used 29 (FIG. 11) and material 33 (FIG. 12) can be fabric, but may be any material especially material commonly used in the clothing industry.

Common leg-warmers or gaiters 29 may also be augmented with the invention. The traces 2 are sewn or otherwise attached onto the outer material, ideally toward the top of the gaiter. The gaiter should close any gaps against the user's skin by using a gasket material, Elastic fabric, or any other means at the bottom end of the gaiter 31 in order to prevent ticks from getting under the gaiter material and in between the skin and device, thereby bypassing detection. All device electronics 32 can be sewn into a pocket within the gaiter fabric or material, or can be located anywhere practical.

In another embodiment, referring to FIG. 12, socks can also be used to implement this device; preferably tall socks that reach up as high as practical on the leg. The device's electronics 32 and traces 2 are then integrated into the sock instead of into a band. Again, the ideal location for the traces 2 are as high up as practical. Further, tall socks reaching ideally as high as just below the knee are ideal, although any height sock is acceptable, with shorter socks able to detect fewer ticks which may be deposited higher up on the leg.

Referring to FIG. 13, optical detection may be utilized in place of electrical detection. Instead of conductive traces, a single substrate 35 following the same geometry as a pair of conductive traces has, mounted on its surface, light emitting and detecting surface mount components 34 and 36 respectively, light pipes, or fiber optics, arranged such that when a tick is on top of the substrate, it modifies light received by an emitter from a detector. Depending on the arrangement, the tick may block an existing light path or cause one to appear (i.e. by unblocking a light path or reflecting light). The same concept can be applied to the traces, for detection purposes.

The substrate 35 may be on material such as flex circuit board, stretch fabric with conductive thread as in an e-textile, or any material convenient for mounting the detector and emitters. The entire assembly may be embedded in silicone, fabric or otherwise covered to allow the tick a smooth surface to traverse. The block diagram behind this embodiment is the same as with the conductive traces and is shown in FIG. 4. The detector simply utilizes a signal derived from one or more optical detectors, and the signal generator drives the light emitters, effectively replacing 2 with optical emitters and detectors. Unfortunately, with an optical approach no stun, kill, or is available.

Some ways of alerting:
LED lights up/flashes on the device
Bluetooth/RF/wireless alert that goes to the internet or your phone to alert via an app.
Vibrating motor
Electronic stimulation of human muscle via pulsed high voltage (using methods commonly used in electronic muscle stimulator arts)
As mentioned above, a buzzer/audible alert (piezo).

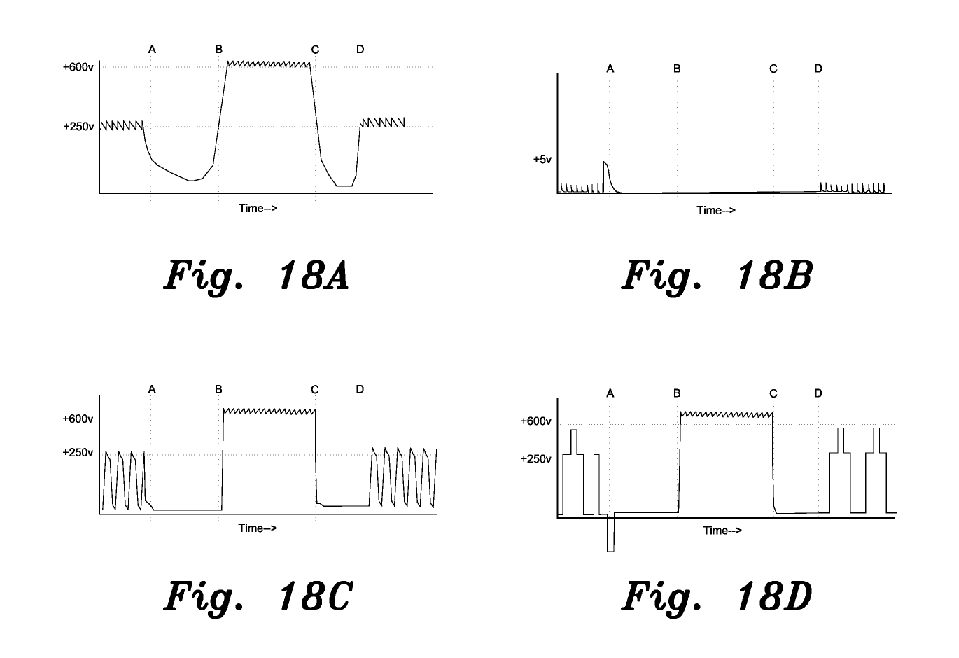

FIG. 18A, FIG. 18B, FIG. 18C, and FIG. 18D are graphs depicting signals and events related to the operation of the circuit arrangements of FIG. 8A, FIG. 8B, and FIG. 8C.

Signals involved with an embodiment using the arrangement shown in FIG. 8B are in FIG. 18A and FIG. 18B. Prior to event A, FIG. 18A shows the signal generator producing a nominal 250 volts, while FIG. 18B shows the detector receiving noise well below a 5 v threshold. Event A signifies a tick bridging the traces. At this moment, all current produced by the generator is shorted into the detector, causing the voltage at the detector to briefly rise above a threshold (in this case near 5 volts), however the presence of the tick prevents the voltage at the generator 10 from rising. The tick is now shorting any current available to raise the voltage on the driven trace into the detector, which acts as a load. Since the detector 10 has now measured the brief rise of voltage over a threshold at event A, and now the voltage cannot rise back to a nominal level, the device has detected a tick. It responds by outputting a stun voltage of 600 v at event B for a period of time. The device then turns off the stun voltage at event C and transitions back to the detection voltage at event D.

Signals involved with an embodiment using the arrangement shown in FIG. 8A are in FIG. 18C. Since the generator 10 and detector 11 are using the same trace, only one voltage level graph is needed. Prior to event A, a signal consisting of pulses of a known frequency at a lower voltage of 250 v is driven into the non-grounded trace. The pulses are spaced apart such that battery life is improved, but not so far apart that ticks can escape detection. When a tick bridges the traces at event A, the pulse duration is shortened and/or the voltage is significantly reduced. This embodiment makes use of the filter of FIG. 16, which triggers since the voltage at event A is now below the low passed threshold. Between event A and B, the tick is shorting the signal to ground, further confirming the presence of a tick to the device. At event B, the device alerts and enters a “stun” mode, applying a significant boost to the generated signal, driving over 600 volts to the trace. This stuns or kills the tick. At event C, the device cycles back to detect mode, removing the stun signal from the traces. At event D, detection resumes.

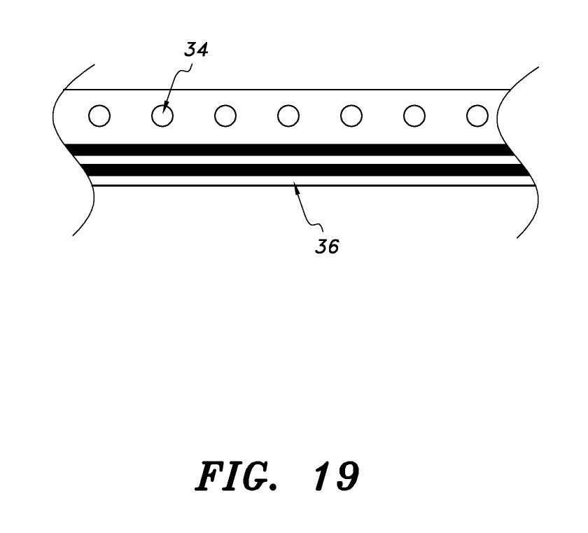

Signals involved with an embodiment using the arrangement shown in FIG. 8C are shown in FIG. 18D. In this arrangement, both generator 10 and detector 11 are on the same side of the trace pair. The signal generator and detector act as a TDR (Time Domain Reflectometer), sending short duration pulses down the transmission line created by the trace pair. When these pulses reach the end of the line, they reflect and return to the detector, adding to the outgoing pulse's voltage where there is overlap, but remain positive going. With a tick present across the traces, a short is formed. This short reflects the outgoing pulse emitted by the signal generator 10 but as a negative going return. Prior to event A, a pulse is sent down the line, and a reflection boosts the voltage even higher where the pulses overlap. At event A, a negative going pulse is reflected from a tick present across the traces, causing the detector to alert. Between event A and B, the signal generator transitions to a stun mode and at event B outputs a stun voltage. At event C the signal generator transitions back to a detect mode, and at event D, detection resumes. Since the velocity factor of the transmission line is known, the duration between the outgoing and incoming pulse indicates exactly where on the trace the tick is located. Standard TDR formulas may be used to calculate the location. In one embodiment, the user is notified of the location of the tick with an LED light 34 on the band which lights up near the tick's location as shown in FIG. 19.

An LED array is shown in FIG. 19, in which one of the LED's of the array is indicated as LED 34. The LED array allows the device to illuminate the LED closest to the detected location in order to help the user find the detected tick. The device may also wirelessly transmits the tick's location to a device with a screen which draws or otherwise describes the location of the tick. All such variations are within the ambit of skill of any one having skill in the LED circuitry arts.

In summary, the arrangements in FIGS. 8A-8C have signals corresponding to those of FIGS. 18A-18D as follows:
Arrangement of FIG. 8A=signal of FIG. 18C (one graph since generator/detector are connected together)
Arrangement of FIG. 8B=signal of FIG. 18A generated, signal of FIG. 18B detected (two graphs since generator is on one trace and detector is on the other)
Arrangement of FIG. 8C=signal of FIG. 18D (one graph since generator/detector are connected together)

FIG. 19 shows one possible arrangement of LEDs on the band. It relates to the three modes shown in FIG. 8A, FIG. 8B, and FIG. 8C. Here, the mode of FIG. 8C is preferably used in the embodiment of FIG. 19, which times the signal reflection using TDR, which measures the distance. By using this distance, the closest LED is lighted, and a circuit (not shown) is provided for this purpose. Circuitry for lighting specific LED's is known, and any one having skill in the LED circuitry arts will know how to make a specific circuit arrangement for lighting a specific LED. It is known that TDR is somewhat similar in nature to sonar, in that the device sends out a “ping” and gets a reflected return. The timing of the return enables calculation of how far down the line the short (or tick in this case) is located.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A tick detecting device for detecting ticks or other insects on the device, comprising:
a supporting material;
a signal generator for generating a detection waveform or DC voltage sufficient to traverse ticks;
at least one pair of conductive traces disposed on said supporting material, wherein one trace of said at least one pair of traces being driven by said signal generator, with said pair of traces being in a path of ticks traversing said supporting material;
a detector for detecting the generated signal from said signal generator and any deviations caused by a tick in contact with said pair of conductive traces;
a filter for discriminating between tick and no tick signals received from at least one of said pair of conductive traces; and
a device for notifying a user of the detection of presence of a tick.

2. A tick detecting device for detecting ticks as claimed in claim 1 which boosts the signal generated to a level capable of stunning, deterring, or killing a detected tick.

3. A tick detecting device for detecting ticks as claimed in claim 1 where the conductive traces are replaced with optical detectors and emitters.

4. A tick detecting device as claimed in claim 1, wherein the device is integrated into a wearable band or loop of material designed to be worn on the user's skin or over clothing

5. A tick detecting device as claimed in claim 4 further comprising of a gasket of material on the bottom edge which seals any gaps between the user's skin and the band preventing the tick from entering the area under the band.

6. A tick detecting device as claimed in claim 4, which has a buckle for adjustment of fit.

7. A tick detecting device as claimed in claim 6 which has a buckle for adjustment, attached at only one end, held in place by pegs or other components which allow the band to stretch freely and independently of the buckle which may remain ridged.

8. A tick detecting device as claimed in claim 6, which has a guide at one end of the band designed to keep the overlapping portion of the band held in the intended position.

9. A tick detecting as claimed in claim 1, wherein the device is integrated into a pair of gaiters which have a gasket or other method of preventing ticks from entering underneath the device on the bottom edge.

10. A tick detecting as claimed in claim 1, wherein the device is integrated into any article of clothing commonly encountered by ticks ascending up the body, including socks, leg warmers, jeans, or gaiters.

11. A tick deterring device as claimed in 1, which has detection and notification features, and only applies a stun/kill/deter signal to the conductive traces.

12. A tick detecting device as claimed in claim 1, with an “early detection” feature in which one trace is in contact with the user's skin and allows detection when the tick touches skin and the one trace at the bottom edge of the band.

13. A tick detecting device as claimed in claim 1, further comprising user notification of a location of the detected tick.

14. A tick detecting device as claimed in claim 1, further comprising any of the following: an illuminated indicator; any of Bluetooth, Wi-Fi, and any other wireless communication means; an output capability for sending an output signal to a device which can be any of a watch, a phone, a pendant, and any other wearable device capable of receiving an alert via one of a software application and a web page.

15. A tick detecting device as claimed in claim 1, further comprising a vibratory alert which includes a vibrating motor.

16. A tick detecting device as claimed in claim 1, further comprising an electronic stimulation of human muscle via pulsed high voltage.

17. A tick detecting device as claimed in claim 1, further comprising an audible alert which includes a piezoelectric buzzer.

18. A tick detecting device, comprising:
a supporting material;
a signal generator for generating a detection waveform or DC voltage sufficient to traverse ticks;
at least one pair of conductive traces disposed on said supporting material, wherein one trace of said at least one pair of traces being driven by said signal generator, with said pair of traces being in a path of ticks traversing said supporting material;
a detector for detecting the generated signal from said signal generator and any deviations caused by a tick in contact with said pair of conductive traces;
a filter for discriminating between tick and no tick signals received from at least one of said pair of conductive traces; and
a device for applying a stun/kill/deter signal to the conductive traces in response to detection of a tick.

19. A tick detecting device, comprising:
a supporting material;
a signal generator for generating a waveform or DC voltage sufficient to traverse ticks;
at least one pair of conductive traces disposed on said supporting material, wherein one trace of said at least one pair of traces being driven by said signal generator, with said pair of traces being in a path of ticks traversing said supporting material; and
a device for applying a stun/kill/deter signal to the conductive traces.
